(19) United States
(12) Patent Application Publication
(10) Pub. No.: US 2007/0086460 A1
(43) Pub. Date: Apr. 19, 2007

(54) Method and apparatus for supporting multicast/broadcast in wireless communication system

(75) Inventors: Jin-Hyeock Choi, Suwon-si (KR); Hee-Jin Jang, Yongin-si (KR); Youn-Hee Han, Guri-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/545,530

(22) Filed: Oct. 11, 2006

Related U.S. Application Data
(60) Provisional application No. 60/725,657, filed on Oct. 13, 2005.

(30) Foreign Application Priority Data
May 17, 2006 (KR) 10-2006-0044438

(51) Int. Cl. H04Q 7/24; H04L 12/56; H04J 3/26

(52) U.S. Cl. 370/390; 370/432; 370/338

(57) ABSTRACT

A method and apparatus for supporting a multicast/broadcast in a wireless communication system are provided. A multicast/broadcast method receives an Internet Protocol (IP) packet from an upper layer, determines whether a multicast destination address or a broadcast destination address is contained in the received IP packet, and transmits a packet in which a connection identifier (CID) for the multicast or the broadcast is selectively attached to the received IP packet according to a result of the determination. Also, the multicast/broadcast method may receive an IP packet from a mobile station, determine whether a first CID for the multicast or the broadcast is contained in the received IP packet, and transmit a packet in which the first CID of the received IP packet is selectively replaced with a second CID according to a result of the determination.

### CROSS-REFERENCE TO RELATED APPLICATIONS

This application claims the benefit under 35 U.S.C. § 119(e) of an U.S. Provisional Application No. 60/725,657, filed on Oct. 13, 2005, in the U.S. Patent and Trademark Office, and under 35 U.S.C. § 119(a) of a Korean Patent Application No. 10-2006-0044438, filed on May 17, 2006, in the Korean Intellectual Property Office, the entire disclosure of both of which are hereby incorporated by reference.

### BACKGROUND OF THE INVENTION

1. Field of the Invention

The present invention relates to a wireless communication system. More particularly, the present invention relates to a method and apparatus for supporting a multicast/unicast so that a Neighbor Discovery Protocol (NDP) of Internet Protocol version 6(IPv6) may be flexibly applied to a portable Internet system according to Institute of Electrical and Electronics Engineers (IEEE) 802.16d/e, wireless broadband Internet (WiBro), World Interoperability for Microwave Access (WiMAX), and the like.

2. Description of Related Art

A fourth generation mobile communication unifies systems, such as IEEE 802.16d/e, WiBro, WiMax, and the like. In the fourth generation mobile communication, satellite networks, wireless networks, digital broadcasting networks, and video broadcasting networks may be unified into a single network and systematically interoperate with each other. Accordingly, a user may utilize a communication service such as a portable Internet in a best state, with any network.

FIG. 1 is a diagram illustrating a conventional wireless communication system 100 environment. Referring to FIG. 1, a first mobile station (MS) 130, a second MS 140, and a third MS 150 may receive a communication service, such as a call, a digital broadcasting, downloading or uploading of digital medial data, and the like, via a base station (BS) 120. The first MS 130, the second MS 140, and the third MS 150 may be a mobile phone, a notebook computer, a personal digital assistant (PDA), and the like. The BS 120 and an access router (AR) 110 are connected to each other, based on an Ethernet protocol. The BS 120 functions as a bridge for a fast connection to an MS. Also, the BS 120 functions to process scheduling of wireless resources and a radio frequency (RF) control function. The AR 110 is an Internet Protocol (IP) terminating point which is mainly in charge of a layer 3 (L3), and routes IP packets so that the IP packets may be appropriately transmitted and received between the BS 120 and each of the first MS 130, the second MS 140, and the third MS 150. The IP packets are transmitted to or received from a destination MS or a destination server via the BS 120.

In the conventional wireless communication system 100 environment according to a system such as IEEE 802.16d/e, WiBro, and WiMAX, the BS 120 supports mobility of MSs according to an Internet Protocol version 6 (IPv6), and supports a unicast. However, while a multicast/broadcast is supported in IEEE 802.11 and wireless LAN (WLAN), the multicast/broadcast is not supported in a portable Internet system according to IEEE 802.16d/e, WiBro, WiMAX, and the like. The unicast designates a one-to-one communication. For example, the unicast corresponds to a communication between a single host and another single host. In this case, the host may be an MS or a predetermined application server which is connected to the Internet. The multicast designates a one-to-many communication. For example, the multicast corresponds to a unidirectional communication from a single host to a group of specific hosts. The broadcast is a particular example of the multicast. Specifically, the broadcast corresponds to a unidirectional communication from a single host to a group of unspecific hosts.

The multicast/broadcast appropriately operates a Neighbor Discovery Protocol (NDP) which is defined in RFC2461 of IPv6. The NDP is a key protocol of IPv6, and is also a protocol for discovering adjacent neighbor nodes. However, in the portable Internet system according to IEEE 802.16d/e, WiBro, WiMAX, and the like, the multicast/broadcast is not supported. Accordingly, overhead occurs when exchanging messages such as a Router Solicitation (RS) message, a Router Advertisement (RA) message, a Neighbor Solicitation (NS) message, a Neighbor Advertisement (NA) message, and the like. In addition, Address Auto-Configuration and Duplicate Address Detection may not be easily performed.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a multicast/broadcast method which can transmit a packet in which a connection identifier (CID) for a multicast/broadcast is attached to a received IP packet to a mobile station, so that the mobile station may be identified in a base station of a system such as IEEE 802.16d/e, WiBro and WiMAX.

An aspect of exemplary embodiments of the present invention is to provide a multicast/broadcast apparatus in a base station for flexibly applying a Neighbor Discovery Protocol (NDP) to a portable Internet system such as IEEE 802.16d/e, WiBro, and WiMAX.

According to an aspect of exemplary embodiments of the present invention, a multicast/broadcast method in a base station is provided. The method comprises receiving an Internet Protocol (IP) packet from an upper layer, determining whether a multicast destination address or a broadcast destination address is contained in the received IP packet, and transmitting a packet in which a connection identifier (CID) for the multicast or the broadcast is selectively attached to the received IP packet according to a result of the determination.

In an exemplary implementation, the multicast/broadcast method is performed in a downlink from the base station to mobile stations. Also, the multicast/broadcast method is performed in a convergence sublayer that is an upper layer of a Media Access Control (MAC) layer which is operated in the base station.

In another exemplary implementation, the multicast/broadcast method inserts and transmits the packet attached with the CID for the multicast or the broadcast into a mobile anchor point (MAP) message, which is a MAC management message, in the MAC layer. Accordingly, specific mobile stations, in an area where the base station covers, may receive the packet attached with the CID, which is a multicast packet. Also, nonspecific mobile stations, in the area where the base station covers, may receive the packet attached with the CID, which is a broadcast packet.

According to anther aspect of exemplary embodiments of the present invention, another multicast/broadcast method in a base station is provided. The method comprises receiving an IP packet from a mobile station, determining whether a first CID for the multicast or the broadcast is contained in the received IP packet, and transmitting a packet in which the first CID of the received IP packet is selectively replaced with a second CID according to a result of the determination.

In an exemplary implementation, the multicast/broadcast method is performed in an uplink from the mobile station to the base station. Also, the multicast/broadcast method is performed in a convergence sublayer that is an upper layer of a MAC layer which is operated in the base station.

In another exemplary implementation, the multicast/broadcast method inserts and transmits the packet in which the first CID is replaced with the second CID in a MAP message, which is a MAC management message, in the MAC layer. Accordingly, specific mobile stations, in an area where the base station covers, may receive the packet in which the first CID is replaced with the second CID, which is a multicast packet. Also, nonspecific mobile stations, in the area where the base station covers, may receive the packet in which the first CID is replaced with the second CID.

In still another exemplary implementation, the multicast/broadcast method is applied to a portable Internet system according to at least one of IEEE 802.16d/e, WiBro, and WiMAX.

According to still another aspect of exemplary embodiments of the present invention, a multicast/broadcast apparatus in a base station is provided. The apparatus comprises a classifier for generating determination information to announce whether a multicast destination address or a broadcast destination address is contained in an IP packet which is received from an upper layer, and a transmission unit for transmitting a packet in which a CID for the multicast or the broadcast is selectively attached to the received IP packet according to the determination information.

According to yet another aspect of exemplary embodiments of the present invention, another multicast/broadcast apparatus in a base station is provided. The apparatus comprises a classifier for generating determination information to announce whether a first CID for the multicast or the broadcast is contained in an IP packet which is received from a mobile station, and a transmission unit for transmitting a packet in which the first CID of the received IP packet is selectively replaced with a second CID according to the determination information.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following detailed description, taken in conjunction with the accompanying drawings in which:

FIG. 1 is a diagram illustrating a conventional wireless communication system environment;

FIG. 2 is a block diagram illustrating a wireless communication system according to an exemplary embodiment of the present invention;

FIG. 3 is a configuration diagram illustrating a convergence sublayer for explaining a unicast of a base station shown in FIG. 2 according to an exemplary embodiment of the present invention;

FIG. 4 is a flowchart illustrating a unicast operation of a base station according to an operation of a convergence sublayer shown in FIG. 3 according to an exemplary embodiment of the present invention;

FIG. 5 is a configuration diagram illustrating a convergence sublayer for explaining a downlink multicast of a base station shown in FIG. 2 according to an exemplary embodiment of the present invention;

FIG. 6 is a flowchart illustrating a downlink multicast operation of a base station according to an operation of a convergence sublayer shown in FIG. 5 according to an exemplary embodiment of the present invention;

FIG. 7 is a configuration diagram illustrating a convergence sublayer for explaining an uplink multicast of a base station shown in FIG. 2 according to an exemplary embodiment of the present invention; and

FIG. 8 is a flowchart illustrating an uplink multicast operation of a base station according to an operation of a convergence sublayer shown in FIG. 8 according to an exemplary embodiment of the present invention.

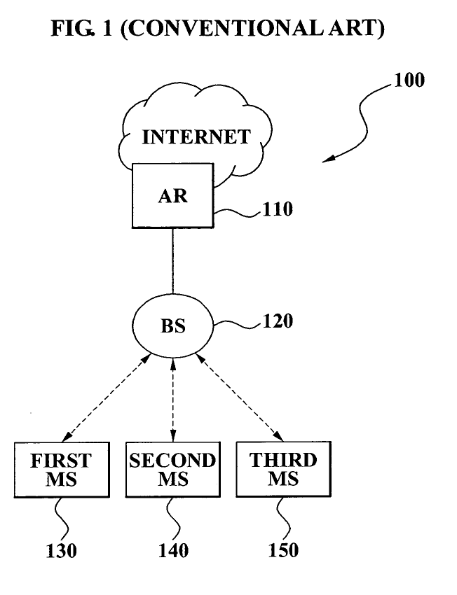

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

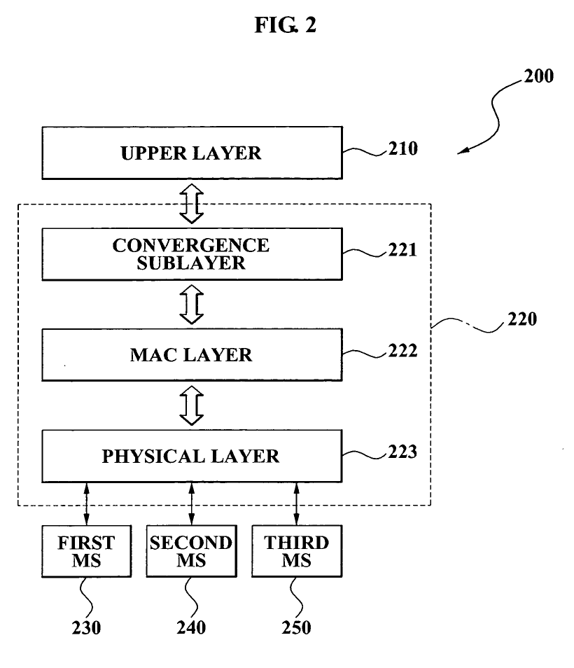

FIG. 2 is a block diagram illustrating a wireless communication system 200 according to an exemplary embodiment of the present invention. Referring to FIG. 2, the wireless communication system 200 includes an upper layer 210, a base station (BS) 220, and a first mobile station (MS) 230, a second MS 240, and a third MS 250. The upper layer 210 corresponds to a bridge, an access router (AR), a host, and the like. The BS 220 corresponds to an access point (AP), a repeater, and the like. The first MS 230, the second MS 240, and the third MS 250 correspond to a mobile phone, a notebook computer, a personal digital assistant (PDA), and the like.

The first MS 230, the second MS 240, and the third MS 250 may communicate with a correspondent node via the upper layer 210 and the BS 220 which are connected to an Internet network. Here, the Internet network includes both a private access network and a public access network. For example, the AR, which is connected to the Internet network, controls a session connection establishment of an incoming call. Also, the AR manages routing so that an Internet Protocol (IP) packet or a message between the BS 220 and each of the first MS 230, the second MS 240, and the third MS 250 may be appropriately transmitted and received. An Authentication/Authority/Accounting (AAA) server, a quality manager, a location register, an application server, and the like, may be connected to the AR via the Internet network.

The BS 220 performs a Radio Resource Control (RRC) function according to scheduling of wireless resources and a handoff function supporting mobility between cells, and thereby, relays a communication of the first MS 230, the second MS 240, and the third MS 250.

The wireless communication system 200 may be applied to IEEE 802.16d/e, WiBro, and WiMAX. In the wireless communication system 200, the BS 220 supports seamless mobility of the first MS 230, the second MS 240, and the third MS 250 according to Internet Protocol version 6 (IPv6). Particularly, in an exemplary embodiment of the present invention, a multicast/broadcast function, which is not supported in IEEE 802.16d/e, WLAN, etc., may be supported in the BS 220. Accordingly, since a one-to-many communication is enabled via the multicast/broadcast, signaling overhead caused by a unicast, which is a one-to-one communication, is reduced. When the multicast/broadcast function is assigned to a portable Internet system according to IEEE 802.16d/e, WiBro, WiMax, and the like, a Neighbor Discovery Protocol (NDP) of Internet Protocol version 6 (IPv6) may be flexibly applied.

For example, signaling messages, which are supported in the NDP, such as a Router Solicitation (RS) message, a Router Advertisement (RA) message, a Neighbor Solicitation (NS) message, a Neighbor Advertisement (NA) message, and the like, may be more easily exchanged. In addition, Address Auto-Configuration and Duplicate Address Detection may be easily performed in a host.

For this, the BS 220 may determine whether a received IP packet is a unicast, and also a multicast/broadcast. For example, when the received IP packet is the multicast/broadcast, the BS 220 may attach and transmit a connection identifier (CID) for the multicast/broadcast to the received IP packet to an MS, so that the MS may be identified.

In FIG. 2, the BS 220 includes a convergence sublayer 221, a Media Access Control (MAC) layer 222, and a physical layer 223.

The convergence sublayer 221 is a sublayer for processing each necessary function for each service type in a layered model of an IP protocol. Specifically, in an exemplary embodiment of the present invention, the convergence sublayer 221 determines whether an IP packet received from the upper layer 210 is a unicast, and also a multicast/broadcast. Depending upon the determination, a corresponding CID is attached. When the IP packet is the unicast, a CID of a general method is attached. When the IP packet is the multicast/broadcast, a CID for the multicast/broadcast which is newly defined in the present invention is attached.

The MAC layer 222 is a layer for performing a control so that a plurality of nodes may share the base station 220. The MAC layer 222 controls an error of a packet which is transferred from a upper/lower layer, and transmits a frame formatted packet, which can be recognized by the upper/lower layer, to each of the upper/lower layer. The physical layer 223 transmits the packet, which is transmitted from the MAC layer 222, to the first MS 230, the second MS 240, and the third MS 250 according to a transmission method, and performs an inverse process thereto.

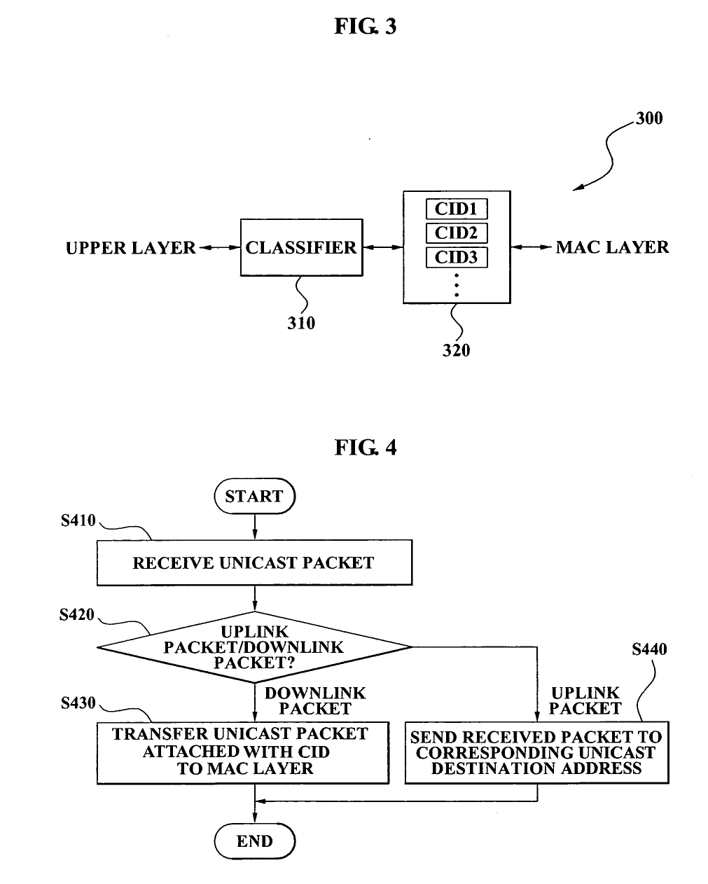

Hereinafter, a method of supporting a unicast and a multicast/broadcast in the BS 220 will be described with reference to FIGS. 3 through 8.

FIG. 3 is a configuration diagram illustrating a convergence sublayer 300 for explaining a unicast of the BS 220 shown in FIG. 2 according to an exemplary impediment of the present invention. Referring to FIG. 3, the convergence sublayer 300 includes a classifier 310 and a transmission unit 320. Operations of the convergence sublayer 300 will be described with reference to FIG. 4.

How the unicast is supported in the BS 220 is similar to general methods, and will be briefly described with reference to FIG. 4. In step S410, when the BS 220 receives a unicast packet from an MS, the classifier 310 generates information to announce that the received packet is the unicast packet. In step S420, the classifier 310 determines whether the received packet is a downlink packet or an uplink packet.

In step S430, when the received packet is the downlink packet, the transmission unit 320 attaches a CID corresponding to a unicast destination address to the received packet, and transfers the packet which is attached with the CID to the MAC layer 222. For example, CID1, CID2, CID3, . . . , may be attached to the received packet for each unicast destination address. Here, the CIP is preferably a 16 bit identifier which is attached to a MAC header to identify MSs, for example, hosts.

The MAC layer 222 inserts and announces the packet which is transferred from the convergence sublayer 300, into a mobile anchor point (MAP) message, which is a MAC management message, so that a corresponding MS may receive the packet. The MAP message is utilized to announce a result of how resources are dynamically allocated for each MS in IPv6. When the received packet is the uplink packet, the transmission unit 320 transmits the received packet to a corresponding unicast destination address in step S440.

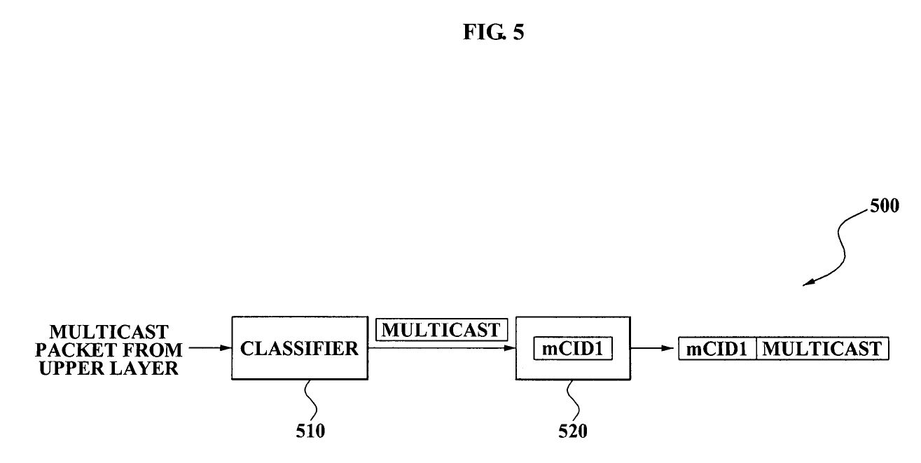

FIG. 5 is a configuration diagram illustrating a convergence sublayer 500 for explaining a downlink multicast of the BS 220 shown in FIG. 2 according to an exemplary embodiment of the present invention. Referring to FIG. 5, the convergence sublayer 500 includes a classifier 510 and a transmission unit 520. The classifier 510 may be integrated with the classifier 310 shown in FIG. 3, and the transmission unit 520 may also be integrated with the transmission unit 320 shown in FIG. 3.

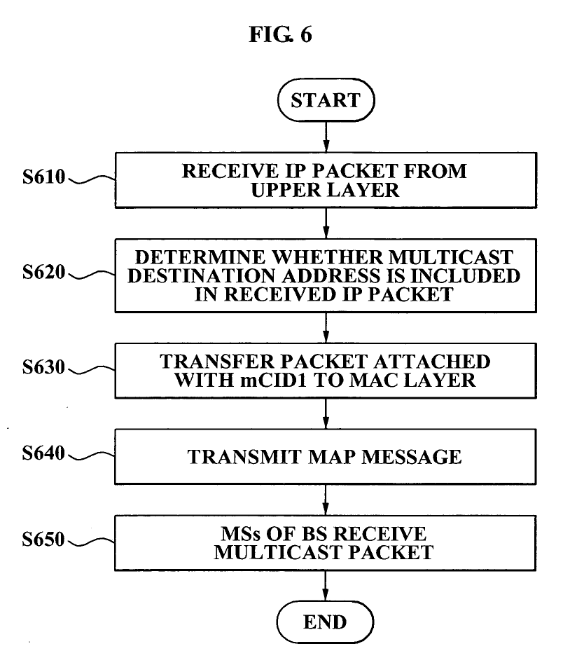

Hereinafter, operations of the convergence sublayer 500 will be described with reference to FIG. 6. FIGS. 5 and 6 illustrate an example of a downlink multicast, which may be similarly applied to a downlink broadcast.

In a downlink multicast or a downlink broadcast process of the BS 220 according to an exemplary embodiment of the present invention, the BS 220 receives an IP packet from the upper layer 210 in step S610. In step S620, the classifier 510 determines whether a multicast destination address or a broadcast destination address is included in the received IP packet. The classifier 510 may generate determination information to indicate whether the multicast destination address or the broadcast destination address is included in the received IP packet. The multicast destination address or the broadcast destination address is defined to be within a predetermined range in IPv6, for example, the most significant 8 bits may be allocated to 0×FF.

When the received IP packet is determined to be not a multicast or a broadcast according to the determination information, the transmission unit 520 may perform a unicast operation in the same way as the transmission unit 320 shown in FIG. 3.

When the received IP packet is determined to be the multicast or the broadcast according to the determination information, the transmission unit 520 transmits a packet in which a CID for the multicast or the broadcast is attached to the received IP packet, for example, the packet which is attached with mCID1, to the MAC layer 222 in step S630. Here, the mCID1 is defined for supporting the multicast or the broadcast, and may be a 16 bit identifier which is attached to a MAC header instead of the general CID shown in FIG. 3.

In step S640, the MAC layer 222 inserts and announces the packet in which the CID for the multicast or the broadcast, mCID1, is attached to the received IP packet, into a MAP message which is a MAC management message, so that corresponding MSs may receive the packet. In step S650, when the received IP packet is a multicast packet, specific MSs, for example, the first MS 230, the second MS 240, and the third MS 250, in an area where the BS 220 covers, may receive the packet which is attached with the mCID1. The specific MSs may be identified by the mCID1. Also, in step S650, when the received IP packet is a broadcast packet, nonspecific MSs, for example, the first MS 230, the second MS 240, and the third MS 250 which can be identified by the mCID1 in the area where the BS 220 covers, may receive the packet which is attached with the mCID1.

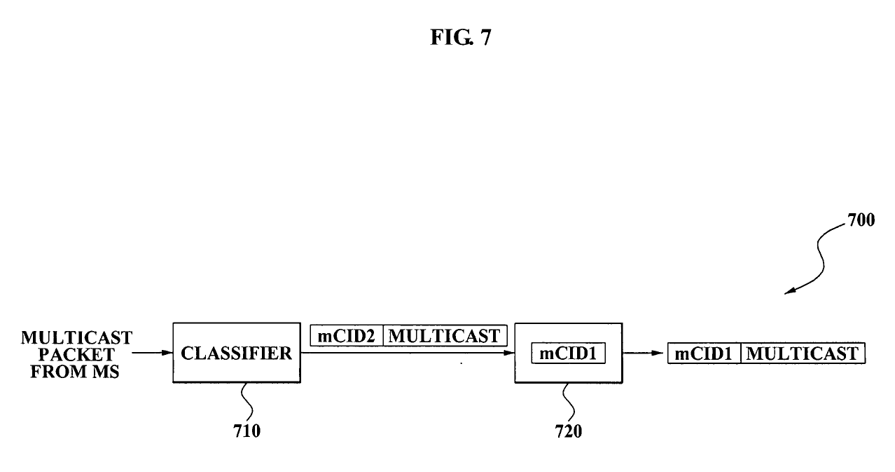

FIG. 7 is a configuration diagram illustrating of a convergence sublayer 700 for explaining an uplink multicast of the BS 220 shown in FIG. 2 according to an exemplary embodiment of the present invention. Referring to FIG. 7, the convergence sublayer 700 includes a classifier 710 and a transmission unit 720. The classifier 710 may be integrated with the classifier 310 shown in FIG. 3, and the transmission unit 720 may also be integrated with the transmission unit 320 shown in FIG. 3.

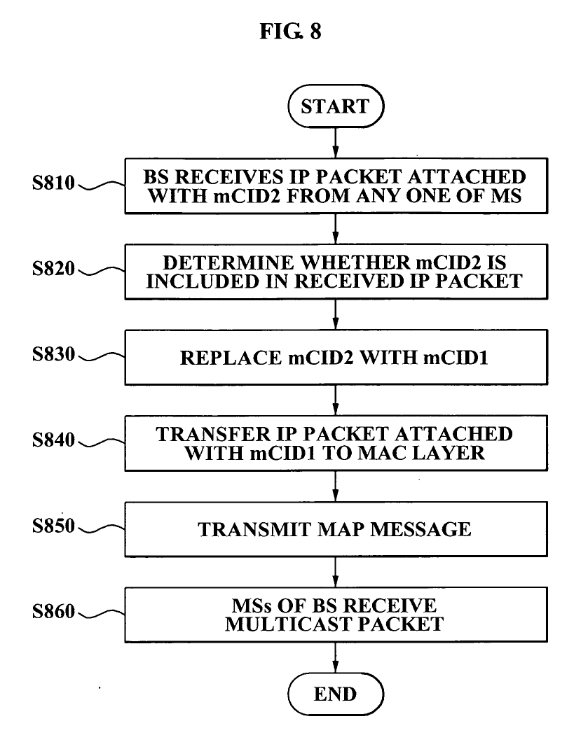

Hereinafter, operations of the convergence sublayer 700 will be described with reference to FIG. 8. FIGS. 7 and 8 illustrate an example of an uplink multicast, which may be similarly applied to an upink broadcast.

In an uplink multicast or an uplink broadcast process of the BS 220 according to an exemplary embodiment of the present invention, the BS 220 receives an IP packet from any one, for example, of the first MS 230, the second MS 240, and the third MS 250 in step S810. In step S820, the classifier 710 determines whether a CID for the multicast or the broadcast, for example, mCID2, is included in the received IP packet. The classifier 710 may generate determination information to indicate whether the mCID2 is included in the received IP packet.

When the received IP packet is determined to be not a multicast or a broadcast according to the determination information, the transmission unit 720 may perform a unicast operation in the same way as the transmission unit 320 shown in FIG. 3.

When the received IP packet is determined to be the multicast or the broadcast according to the determination information, the transmission unit 720 replaces the mCID2, which is included in the received IP packet, with another CID, for example, mCID1, in step S830. Here, the mCID1 and mCID2 are defined for supporting the multicast or the broadcast, and may be a 16 bit identifier which is attached to a corresponding MAC header instead of the general CID shown in FIG. 3. The mCID1 which had been described with reference to FIG. 5 may be identical to the mCID1 which has been described with reference to FIG. 7.

In step S840, the received IP packet in which the mCID2 is replaced with the mCID1 is transmitted to the MAC layer 222. In step S850, the MAC layer 222 inserts and announces the packet in which the mCID2 is replaced with the mCID1, into a MAP message which is a MAC management message, so that corresponding MSs may receive the packet. In step S860, when the received IP packet is a multicast packet, specific MSs, for example, the first MS 230, the second MS 240, and the third MS 250, in an area where the BS 220 covers, may receive the packet in which the mCID2 is replaced with the mCID1 . The specific MSs may be identified by the mCID1. Also, in step S860, when the received IP packet is a broadcast packet, nonspecific MSs, for example, the first MS 230, the second MS 240, and the third MS 250 which can be identified by the mCID1 in the area where the BS 220 covers may receive the packet in which the mCID2 is replaced with the mCID1.

When the multicast/broadcast function according to exemplary embodiments of the present invention is applied to a portable Internet system according to at least one of IEEE 802.16d/e, WiBro, WiMAX, and the like, the NPD of IPv6 may be flexibly applied. Accordingly, signaling overhead by neighbor discovery may be significantly reduced.

As described above, in a wireless communication system and a multicast/broadcast method according to an exemplary embodiment of the present invention, since a multicast/broadcast function is assigned to a portable Internet system according to IEEE 802.16d/e, WiBro, WiMAX, and the like, the NPD of IPv6 may be flexibly applied. Accordingly, signaling messages, which are supported in the NDP, such as an RS message, an RA message, an NS message, an NA message, and the like, may be easily exchanged. In addition, Address Auto-Configuration and Duplicate Address Detection may be more easily performed in a host.

Certain aspects of the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves, such as data transmission through the Internet. The computer-readable recording medium can also be distributed over network coupled computer systems so that the computer-readable code is stored and executed in a distributed fashion.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A multicast/broadcast method comprising:
receiving an Internet Protocol (IP) packet from an upper layer;
determining whether the received IP packet comprises at least one of a multicast destination address and a broadcast destination address; and
transmitting a packet in which a connection identifier (CID) for the multicast or the broadcast is selectively attached to the received IP packet according to a result of the determination.

2. The method of claim 1, wherein the multicast/broadcast method is performed in a downlink from a base station to a mobile station.

3. The method of claim 1, wherein the multicast/broadcast method is performed in a convergence sublayer, convergence sublayer comprising an upper layer of a Media Access Control (MAC) layer which is operated in a base station.

4. The method of claim 3, further comprising:
inserting the packet comprising the CID for the multicast or the broadcast into a mobile anchor point (MAP) message, the MAP message comprising a MAC management message, in the MAC layer.

5. The method of claim 4, wherein specific mobile stations, in an area of coverage of the base station receive the packet comprising the CID, the packet comprising a multicast packet or nonspecific mobile stations, in the area of the coverage of the base station, receive the packet attached with the CID, which is a broadcast packet.

6. The method of claim 1, wherein the multicast/broadcast method is applied to a portable Internet system in accordance with at least one of Institute of Electrical and Electronics Engineers (IEEE) 802.16d/e, wireless broadband Internet (WiBro), and World Interoperability for Microwave Access (WiMAX).

7. A multicast/broadcast method comprising:
receiving an Internet Protocol (IP) packet from a mobile station;
determining whether the received IP packet comprises at least one of a first connection identifier (CID) for the multicast and the broadcast; and
transmitting a packet in which the first CID of the received IP packet is selectively replaced with a second CID according to a result of the determination.

8. The method of claim 7, wherein the multicast/broadcast method is performed in an uplink from a mobile station to a base station.

9. The method of claim 7, wherein the multicast/broadcast method is performed in a convergence sublayer, the convergence sublayer comprising an upper layer of a Media Access Control (MAC) layer which is operated in a base station.

10. The method of claim 9, further comprising:
inserting the packet in which the first CID is replaced with the second CID in a mobile anchor point (MAP) message, the Map message comprising a MAC management message, in the MAC layer.

11. The method of claim 10, wherein specific mobile stations, in an area of the coverage of the base station, receive the packet in which the first CID is replaced with the second CID, which is a multicast packet, or
nonspecific mobile stations, in the area of the coverage of the base station, receive the packet in which the first CID is replaced with the second CID.

12. The method of claim 7, wherein the multicast/broadcast method is applied to a portable Internet system in accordance with at least one of Institute of Electrical and Electronics Engineers (IEEE) 802.16d/e, wireless broadband Internet (WiBro), and World Interoperability for Microwave Access (WiMAX).

13. A multicast/broadcast apparatus comprising:
a classifier for generating determination information comprising an indication whether an Internet Protocol (IP) packet which is received from an upper layer comprises a multicast destination address or a broadcast destination address; and
a transmission unit for transmitting a packet in which a connection identifier (CID) for the multicast or the broadcast is selectively attached to the received IP packet according to the determination information.

14. The multicast/broadcast apparatus of claim 13, wherein the multicast/broadcast apparatus supports a downlink from a base station to mobile stations.

15. The multicast/broadcast apparatus of claim 13, wherein a convergence sublayer that is an upper layer of a Media Access Control (MAC) layer which is operated in a base station comprises the multicast/broadcast apparatus.

16. The multicast/broadcast apparatus of claim 13, further comprising:
a Media Access Control (MAC) layer for inserting the packet attached with the CID for the multicast or the broadcast into a mobile anchor point (MAP) message, the MAP comprising a MAC management message.

17. The multicast/broadcast apparatus of claim 13, wherein specific mobile stations, in an area of coverage of the base station, receive the packet attached with the CID, the packet comprising a multicast packet, or
nonspecific mobile stations, in the area of coverage of the base station, receive the packet attached with the CID, the packet comprising a broadcast packet.

18. The multicast/broadcast apparatus of claim 13, wherein the multicast/broadcast apparatus is applied to a portable Internet system in accordance with at least one of Institute of Electrical and Electronics Engineers (IEEE) 802.16d/e, wireless broadband Internet (WiBro), and World Interoperability for Microwave Access (WiMAX).

19. A multicast/broadcast apparatus comprising:
a classifier for generating determination information comprising an indication whether an Internet Protocol (IP) packet which is received from a mobile station comprises at least one of a first connection identifier (CID) for a multicast destination address and a broadcast destination address; and
a transmission unit for transmitting a packet in which the first CID of the received IP packet is selectively replaced with a second CID according to the generated determination information.

20. The multicast/broadcast apparatus of claim 19, wherein the multicast/broadcast apparatus supports an uplink from the mobile station to a base station.

21. The multicast/broadcast apparatus of claim 19, wherein a convergence sublayer that is an upper layer of a MAC layer which is operated in the base station comprises the multicast/broadcast apparatus.

22. The multicast/broadcast apparatus of claim 19, further comprising:
a Media Access Control (MAC) layer for inserting the packet in which the first CID is replaced with the second CID in a mobile anchor point (MAP) message, the MAP message comprising a MAC management message.

23. The multicast/broadcast apparatus of claim 19, wherein specific mobile stations, in an area of the coverage of the base station, receive the packet in which the first CID is replaced with the second CID, the packet comprising a multicast packet, or
nonspecific mobile stations, in the area of the coverage of the base station, receive the packet in which the first CID is replaced with the second CID.

24. The multicast/broadcast apparatus of claim 19, wherein the multicast/broadcast apparatus is applied to a portable Internet system in accordance with to at least one of Institute of Electrical and Electronics Engineers (IEEE) 802.16d/e, wireless broadband Internet (WiBro), and World Interoperability for Microwave Access (WiMAX).
